(19) United States
(12) Patent Application Publication
(10) Pub. No.: US 2005/0126286 A1
(43) Pub. Date: Jun. 16, 2005

(54) Method for balancing a movable member and member formed thereby

(75) Inventors: Christopher Hable, Romeo, MI (US); David Carlson, Rochester Hills, MI (US); Kevin Hicks, Harrison Township, MI (US); David Stolarski, Shelby Township, MI (US); Michael J. Czaplicki, Rochester, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/001,968

(22) Filed: Dec. 2, 2004

Related U.S. Application Data
(60) Provisional application No. 60/528,562, filed on Dec. 10, 2003.

(51) Int. Cl. B32B 3/02

(52) U.S. Cl. 73/462

(57) ABSTRACT

A member is balanced by determining a target location at which weight is needed to counter an imbalance. A weighted adhesive is applied to the target location to then balance the member.

### CLAIM OF BENEFIT OF FILING DATE

The present application claims the benefit of the filing date of U.S. Provisional Application Ser. No. 60/528,562, filed Dec. 10, 2003, hereby incorporated by reference.

### FIELD OF THE INVENTION

The present invention relates a method for balancing a movable member such as a driveshaft of an article of manufacture such as an automotive vehicle.

### BACKGROUND OF THE INVENTION

Transportation vehicles (e.g., automotive vehicles) or other articles of manufacture such as lawn mowers, drills, appliances or the like have movable members that experience relatively rapid movements (e.g., rotations). For example, a driveshaft of an automotive vehicle often rotates at high speeds or rates during operation of the vehicle. As a result of such rapid movement, it often becomes important that these movable members are well balanced (e.g., balanced about an axis of rotation) such that the members do not experience forces (e.g., centrifugal forces), which can cause undesirable wear and fatigue. Thus, in the interest of providing well balanced movable members, the present invention discloses an improved method of balancing such members and members formed thereby.

### SUMMARY OF THE INVENTION

Accordingly, a method for balancing a movable member such as a driveshaft of an article of manufacture such as an automotive vehicle is disclosed. The method typically includes determination of at least one imbalance of the movable member. Thereafter, a weighted adhesive is typically applied to the member to counter the imbalance.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of a driveshaft assembly of an automotive vehicle prior to balancing according to an exemplary aspect of the present invention.

FIG. 2 is a perspective view of the driveshaft assembly of FIG. 1 during balancing according to an exemplary aspect of the present invention.

FIG. 3 is a perspective view of the driveshaft assembly of FIG. 1 and 2 after balancing according to an exemplary aspect of the present invention.

### DETAILED DESCRIPTION OF THE PREFERRED EMBODIMENT

The present invention is predicated upon the provision of a method of balancing a movable member of an article of manufacture and a movable member formed thereby. Generally, it is contemplated that the method may be employed to balance and form a large variety of different members for various different articles of manufacture. As examples, it is contemplated that the balancing method may be used to balance movable members such as rotatable members, pendulum members, pulleys, propellers, propellor shafts, wheels, flywheels, combinations thereof or the like of articles of manufacture such as lawn mowers, appliances, transportation vehicles (e.g., watercraft, aircraft, automotive vehicles, motorcycles, recreation vehicles (e.g., ATVs), busses, trains or the like), pulley systems, weed wackers, presses, drills, saws or the like. The balancing method of the present invention has been found particularly useful for balancing driveshafts of transportation vehicles.

The method of balancing a movable member of an article of manufacture includes:
i) providing a movable member;
ii) determining an imbalance of the movable member about at least one point; and
iii) applying (e.g., adhering) a weighted adhesive to the member to counter the imbalance.

As used herein, the term “movable member” is intended to mean a member of an article of manufacture wherein the member is configured to move during use or operation of the article of manufacture. The movable member may be provided as a standard or non-standard component of an article of manufacture. The member may be an assembly of multiple parts formed of multiple materials or may be a single part formed of a single material. Moreover, the movable member may be configured to move in a variety of manners (e.g., oscillate, rotate, reciprocate, vibrate, combinations thereof or the like). The balancing method has been found particularly effective for balancing members that are configured to rotate about a point or an axis. For illustrative purposes, the drawings for the present invention show a driveshaft of an automotive vehicle, however, the present invention should not be so limited unless otherwise stated.

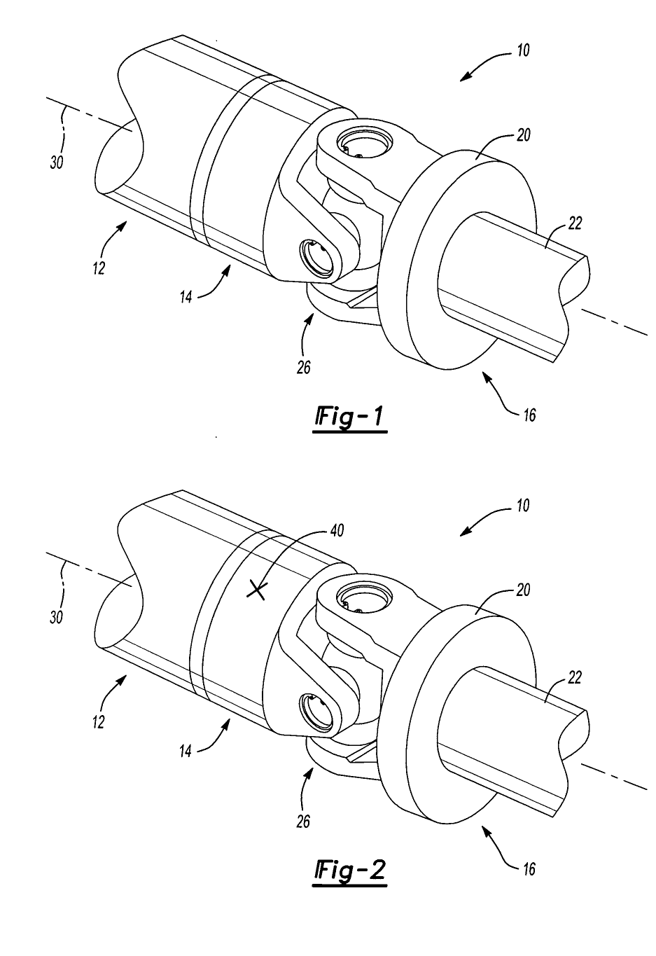

Referring to FIG. 1, there is a movable member 10, which is illustrated as a driveshaft assembly of an automotive vehicle. The member 10 includes a first generally round (e.g., cylindrical) structure 12, which is shown as a shaft or driveshaft and a second generally round (e.g., cylindrical) structure 14, which is shown as a yoke. The member 10 also includes a third generally round (e.g., cylindrical) structure 16, which includes a disk portion 20 and a rod portion 22. In the illustrated embodiment, the third structure 16 is a spindle or second shaft. As can be seen, the first structure 12 is fastened to the second structure 16 with one or more fastening mechanisms 26, shown as a universal joint or constant velocity joint (CVJ).

The movable member and each of its parts or portions may be formed of or include a variety of materials such as metal (e.g., steel, aluminum, magnesium, iron, titanium), polymeric materials, fibrous materials or a combination thereof. It is contemplated that the movable member and its parts or portions may be formed of a singular material or a composite material. For instance, the moveable member and its parts or portions, particularly when the movable member is a driveshaft, although not required, may be formed of a composite material that includes a fibrous material impregnated by a matrix material. As one example of such a composite, the movable member may be formed of carbon fiber windings (e.g., that are wound around a mandrel) impregnated by an epoxy-based material or resin.

The movable member of the present invention is typically configured for moving (e.g., rotating) about at least one point during use or operation of article of manufacture. In FIG. 1, the movable member 10 is configured to rotate about an axis 30 when it is placed within an automotive vehicle. As can be seen, the axis 30 extends along a length of the first structure 12, the second structure 14, the third structure 16, the entire member 10 or a combination thereof.

Once provided, an imbalance of the movable member is typically determined and a target location at which a counter weight is needed to counter the imbalance is also typically determined. Various protocols may be employed for determining the imbalance and the target location. According to one protocol, the imbalance is determined using a machine that moves the member in a manner that simulates the desired movement of the member while in use. For example, the machine might move the member about the point or axis, which the member is configured to move about during operation or use of the member within an article of manufacture. During such movement, the machine determines one or more locations of lower weight, which cause an imbalance in the movement of the member by the machine and determines one or more target locations where a counter weight is desired for balancing the member. The machine or method also typically determines a target amount (e.g., weight or mass) of counter weight needed at the target location.

One exemplary machine, which may be used to determine an imbalance of a member is a balancer (e.g., a propshaft balancer, a driveshaft balancer or a propshaft/driveshaft balancer). One example of such a balancer is commercially available as the 500 or 501 RBRQ machines from the Schenk Ro Tec Corporation, 2890 John R. Road, Troy, Mich. Another example of such a balancer is commercially available as a CEMB Balancing Machine from VibraSys, West Babylon, N.Y.

According to one embodiment of the present invention, the movable member (e.g., the driveshaft) is loaded to (e.g., clamped upon) the balancer and spun at rate typically greater than about 600 revolutions per minute (RPMs) and more typically greater than 1000 RPMs (e.g., about 3200 RPMs). The balancer then detects any imbalance and indicates the target location and target amount of counter weight needed at the target location to counter the imbalance and/or balance the movable member. For example, the balancer may provide a light or laser, which points out the location at which a counter weight is needed and the location may be marked at that location. Moreover, the balancer may include a readout providing the target amount of weight needed to provide balance or a balance correction (i.e., counter the imbalance). As can be seen, a target location 40 has been indicated on the second structure 14 of movable member 10 in FIG. 2.

Once an imbalance in a member is identified, a weighted adhesive (typically the target amount of adhesive) is applied (e.g., adhered) to the member and is typically applied at the target location. As used herein, a weighted adhesive is intended to mean an adhesive having a substantial weight percentage of one or more dense ingredients wherein the one or more dense ingredients have a density of at least about 2 grams/cm³, more typically at least about 8 grams/cm³ and even more typically at least about 15 grams/cm³. As used herein, the phrase “a substantial weight percentage”, as used to reference the dense components within the adhesive, means at least about 30% by weight, more typically at least about 45% by weight and even more typically at least about 55% by weight. Accordingly, the dense components can assist in providing a weighted adhesive having a density of at least about 0.80 grams/cm³, more typically at least about 1.5 grams/cm³, even more typically at least about 2.0 grams/cm³ and even more typically at least about 3.0 grams/cm³. It should be understood that, as used herein, the term adhesive only requires that the adhesive be capable of adhering to one substrate or member, there is no requirement that the adhesive adhere to more than one substrate or member unless otherwise stated.

The weighted adhesive may be a one component or a two component adhesive as those terms are used in the art. As such, the weight percentages listed for the components of the adhesive are for the overall adhesive (i.e., the weight percentage of the one component for a one component adhesive or the weight percentage of both of the components for a two component adhesive) unless otherwise indicated.

Typically, the weighted adhesive includes one or more polymeric resins, one or more curing agents and one or more dense ingredients. Optionally, the weighted adhesive can include one or more fillers, one or more additives (e.g., pigments, rheology modifiers, thixotropic materials, adhesion promoters, binders), combinations thereof or other additional ingredients. It is also contemplated, however, the adhesive may be a hot-melt adhesive based upon thermoplastic materials such as polyamides, polyesters, EVAs, combinations thereof or the like.

The one or more polymeric resins can include epoxy-based resins, polyurethane resins, combinations thereof or other resins employed in forming adhesives. Typically, although not necessarily, the adhesive will include up to at least about 10% and less than about 80% or greater, more typically between about 15% and about 40% and even more typically between about 20% and about 30% by weight polymeric resin.

Preferably, although not required, the polymeric resin includes one or more epoxy-based materials. The epoxy may be supplied as a solid (e.g., as pellets, chunks, pieces or the like), as a liquid or a combination thereof. Epoxy resin is used herein to mean any of the conventional dimeric, oligomeric or polymeric epoxy materials containing at least one epoxy functional group. Epoxy resin can also mean a single resin or a mixture of resins. The epoxy component may be any epoxy-containing material, which preferably includes one or more oxirane rings polymerizable by a ring opening reaction.

The epoxy or epoxy-based compound may be aliphatic, cycloaliphatic, aromatic or the like. The epoxy or epoxy-base compound may be an adduct (e.g., an epoxy/elastomer adduct). The epoxy or epoxy-based compound may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. One exemplary epoxy resin may be a phenolic, a modified phenolic or an epoxidized phenolic resin, which may be a novalac type or other type resin. Other preferred epoxy containing materials may include a bisphenol-A epichlorohydrin ether polymer, a solid bisphenol-A epoxy resin, a bisphenol-F epoxy resin or the like.

The one or more curing agents of the adhesive will typically depend upon the materials of the polymeric resin. For example, an isocyanate may cure a polymeric resin (e.g., a polyol) for forming a polyurethane or the curing agent may be an amine or an acid when the polymeric resin includes one or more epoxy resins. It is also contemplated that the adhesive can include one or more curing agent accelerators for accelerating cure times for the adhesive.

Amounts of curing agents and curing agent accelerators can vary widely within the adhesive depending upon desired rate of cure, the type of desired cure, the desired strength of the adhesive, the amount of other ingredients in the adhesive, combinations thereof or the like. Exemplary ranges for the curing agents or curing agent accelerators, when used, in the adhesive typically range from about 0.01% by weight to about 7% by weight.

Typically, the curing agents assist the adhesive in curing by crosslinking of the polymers (e.g., epoxy resins) or both. Useful classes of curing agents are materials selected from aliphatic or aromatic amines or their respective adducts, amidoamines, polyamides, cycloaliphatic amines, (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. An accelerator for the curing agents (e.g., a modified or unmodified urea such as methylene diphenyl bis urea, an imidazole or a combination thereof) may also be provided for preparing the expandable material.

The one or more dense ingredients may be formed of a variety of materials having the desired density. Typically, although not required, the dense ingredients can include or be substantially entirely formed of metal such as steel (e.g., stainless steel), iron, tungsten, aluminum, silver, gold, tin, lead, mercury, combinations thereof or the like. In one embodiment, the dense ingredients are non-corrosive, non-anodic, non-galvanic, a combination thereof or the like, although not required. Other potential dense ingredients can include or be substantially entirely formed of minerals or other natural materials. It is also contemplated that the dense ingredients may be compounds or composite materials such a tungsten carbide.

The dense ingredients are typically provided as multiple pieces (e.g., chunks, pellets, shavings, combinations thereof or the like). In a preferred embodiment, the dense ingredients are provide as particulate matter (e.g., powder) and are thus provided as a plethora of particles with each of the particles having all of its dimensions smaller than 5 millimeters, more typically smaller than 1 millimeters and even more typically smaller than 0.3 millimeters. In one preferred embodiment, the dense ingredient is a tungsten or tungsten carbide powder.

The adhesive may also include one or more fillers, including but not limited to particulated materials (e.g., powder), beads, microspheres, or the like. Preferably, the filler is composed of or includes a material that is generally non-reactive with the other components present in the adhesive.

Examples of fillers include silica, diatomaceous earth, glass, clay, talc, pigments, colorants, glass beads or bubbles, glass, carbon ceramic fibers, antioxidants, and the like. Such fillers, particularly clays, can assist the adhesive material in leveling itself application of the adhesive. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular improved the impact resistance of the cured expandable material.

It is contemplated that one of the fillers or other components of the material may be thixotropic for assisting in controlling flow of the material as well as properties such as tensile, compressive or shear strength.

Other Additives

Other additives, agents or performance modifiers may also be included in the weighted adhesive as desired, including but not limited to a UV resistant agent, a flame retardant, an impact modifier, a heat stabilizer, a UV photoinitiator, a colorant, a processing aid, a lubricant, a reinforcement (e.g., chopped or continuous glass, ceramic, aramid, or carbon fiber or the like).

It is also contemplated within the present invention that polymers other than those discussed above such as thermoplastics may also be incorporated into the weighted adhesive, e.g., by copolymerization, by blending, or otherwise. For example, without limitation, other polymers that might be appropriately incorporated into the weighted adhesive include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

For purposes of illustration, Chart A below illustrates an exemplary formulation for an exemplary one component adhesive according to the present invention:

Adhesive Formulation
(% by weight of entire adhesive) 1K

| | % |
|---|---|
| Solid Epoxy Adduct | 10.28 |
| Liquid Epoxy Resin (BPA type) | 10.28 |
| Liquid Epoxy Phenol Novolac Resin | 3.43 |
| Mixed Mineral Thixotrope | 1.00 |
| Pulp Aramid Fiber | 0.36 |
| Tungsten Powder | 71.97 |
| Dicyandiamide (curing agent) | 1.40 |
| Modified Aliphatic Amine (curing agent or curing | 1.28 |
| agent accelerator) | |

Also for purposes of illustration, Chart B below illustrates an exemplary formulation for an exemplary two component adhesive according to the present invention:

Adhesive Formulation
2K

| | % by weight |
|---|---|
| A Side | on A side |
| Liquid Epoxy Resin (BPA type) | 10.46 |
| Solid Epoxy Cresol Novolac Resin | 6.98 |
| Trifunctional Monomer | 11.63 |
| Tungsten Powder | 66.67 |
| Additive, Moisture Scavenger or Binder (e.g., portland | 1.16 |
| cement) | |
| Mixed Mineral Thixotrope | 1.16 |
| Mica | 1.94 |
| | % by weight |
| B Side | on B side |
| Aliphatic Amine | 30.88 |
| Tungsten Powder | 63.24 |
| Mixed Mineral Thixotrope | 2.21 |
| Mica | 3.68 |

For a two-component adhesive, the ratio of the first component (e.g., resin or polymer component) to the second component (e.g., curing component) is typically from about 10:1 to about 1:10 but may be higher or lower, more typically from about 4:1 to about 1:4 and even more typically from about 2:1 to about 1:2. In the example above, one typical ration might be 2 parts A side to one part B side.

Formation of the weighted adhesive can be accomplished according to a variety of new or known techniques. Preferably, the adhesive is formed as a material of substantially homogeneous composition. In particular, it is generally desirable for the one or more dense ingredients to be homogeneously spread throughout a substantial portion (e.g., at least 30% by weight) or throughout substantially the entirety of the adhesive. However, it is contemplated that various combining techniques may be used to increase or decrease the concentration of certain ingredients in certain locations of the adhesive.

According to one embodiment, the adhesive material is formed by supplying the ingredients of the material in solid form such as pellets, chunks and the like, in liquid form or a combination thereof. The ingredients are typically combined in one or more containers. Preferably, the containers can be used to intermix the ingredients by rotating or otherwise moving the container. If needed, heat, pressure or the like may be employed to achieve desired mixing.

For the one component adhesive, each of the ingredients are typically mixed in a single container. However, for the two component adhesive, the A-side and B-side are typically maintained in separate containers until application or shortly before application to the movable member.

The weighted adhesive can be applied (e.g., delivered and placed into contact with) the movable member, or a material or component connected to the movable member, through a variety of techniques and using a variety of delivery systems or dispensers. For example, the adhesive may be applied by dabbing, brushing, pressure ejection from a container, pumping from a pumpable system, combinations thereof or the like. Moreover, the adhesive may be applied manually, semi-automatically (i.e., partially manual and partially automatic) or completely automatically (e.g., robotically).

According to one embodiment, a dispenser is employed to dispense an amount of adhesive at the target location (e.g., the location 40 in FIG. 2) as indicated or marked during the step of determining the imbalance of the movable member. Typically, the amount applied is commensurate with the amount indicated by the balancer or other device. Advantageously, the dispenser can be configured to dispense an amount of adhesive nearly identical to the desired or target amount indicated during the step of determining the imbalance. For example, the dispenser may be equipped with a mass flow meter or other metering device for dispensing particular amounts or weight of adhesive.

If a one component adhesive is employed, the weighted adhesive is typically dispensed from one container, although not required. If a two component adhesive is employed, it is contemplated that the dispenser can dispense one component from one container and the second component from the second container such that the components are mixed upon application.

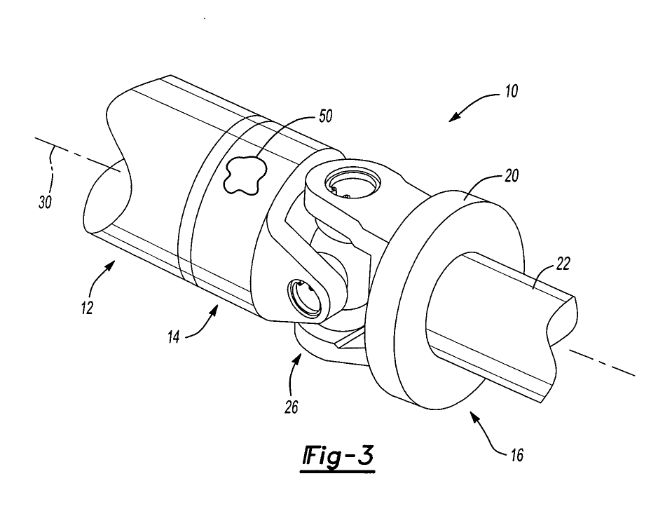

After application, the adhesive is typically allowed to cure. Curing may take place at the temperature of the surrounding environment (e.g., around room temperature) or may take place at elevated temperatures (e.g., by application of heat). Curing may also be partially or fully induced by induction, electromagnetic exposure (e.g., exposure to ultraviolet (UV), infrared (IR), microwave or other radiation or light or combinations thereof), photoinitiation, combinations thereof or the like. As can be seen in FIG. 3, a target amount of adhesive 50 has been applied to the target location 40 of FIG. 2 and has cured.

Upon curing, the adhesive will typically counter the imbalances detected. Of course, it may be desirable to again test the member to assure such balance and potentially apply additional adhesive or remove adhesive if such secondary testing continues to indicate imbalance. Thus, it should be understood that multiple target locations and target amounts may be determined for one moveable member and the multiple target amounts of weighted adhesive may be applied to the movable member. Advantageously, the movable member can then be assembled to an article of manufacture and the movable member will typically operate without experiencing undue forces caused by imbalances.

In one alternative embodiment, it is contemplated that the adhesive, whether a weighted adhesive or a non-weighted adhesive, may be employed to attached one or more weights to the moveable member. In such an embodiment, each of the steps or techniques above may be employed with the exception that the adhesive is used to adhere a separate weight to the moveable member at one or more target locations. Accordingly, the adhesive would be applied to the moveable member, the one or more weights or both and then the one or more weights would be placed adjacent the one or more target locations for adhering the one or more weights thereto. Typically, the one or more weights applied along with the weight of the adhesive would be commensurate with the target amount of weight need to balance the

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method for balancing a movable member of an article of manufacture, the method comprising:
providing a movable member;
determining an imbalance of the movable member about at least one point; and
applying a weighted adhesive to the member to counter the imbalance.

2. A method as in claim 1 wherein the member is selected from an axle, a pulley, a propeller, a propeller shaft, a wheel or a flywheel.

3. A method as in claim 1 wherein the article of manufacture is selected from a lawn mower, an appliance, a transportation vehicle, a pulley system, a weed whacker, a press, a drill or a saw.

4. A method as in claim 1 wherein the movable member is configured to rotate about at least one point upon assembly to the article of manufacture.

5. A method as in claim 1 wherein the member is a driveshaft, the article of manufacture is an automotive vehicle and the imbalance is determined by a balancer.

6. A method as in claim 1 wherein the adhesive includes a substantial weight percentage of one or more dense ingredients.

7. A method as in claim 6 wherein the adhesive includes one or more polymeric materials and one or more curing agents.

8. A method as in claim 7 wherein the adhesive includes a polymeric resin selected from an epoxy based resin or a polyurethane resin.

9. A method as in claim 8 wherein the dense ingredients are provided as particulate matter and the dense ingredients include a metal selected from steel, iron, tungsten, aluminum, silver, gold, tin, lead or mercury.

10. A method as in claim 8 wherein the one or more dense ingredients include tungsten.

11. A method as in claim 6 wherein the one or more dense ingredients have density of at least about 8 grams/cm³.

12. A method as in claim 1 wherein the weighted adhesive has a density of at least about 2 grams/cm³.

13. A method for balancing a driveshaft of an automotive vehicle, the method comprising:
providing a driveshaft of an automotive vehicle wherein the driveshaft has an axis of rotation about which the driveshaft is configured to rotate about upon assembly to an automotive vehicle;
determining an imbalance of the driveshaft by loading the driveshaft to a balancer wherein:
i) the balancer rotates the driveshaft about the axis of rotation;
ii) the balancer detects one or more imbalances of the driveshaft; and
iii) the balancer indicates one or more target locations upon the driveshaft to which counterweight should be added to counter the one or more imbalances;
applying a weighted adhesive to the one or more target locations to counter the one or more imbalances.

14. A method as in claim 13 wherein the adhesive includes a substantial weight percentage of one or more dense ingredients.

15. A method as in claim 13 wherein the adhesive includes a epoxy-based polymer resin and one or more curing agents.

16. A method as in claim 14 wherein the dense ingredients are provided as particulate matter and the dense ingredients include a metal selected from steel, iron, tungsten, aluminum, silver, gold, tin, lead or mercury.

17. A method as in claim 14 wherein the one or more dense ingredients include tungsten.

18. A method as in claim 14 wherein the one or more dense ingredients have density of at least about 8 grams/cm³ and the weighted adhesive has a density of at least about 2 grams/cm³.

19. A method for balancing a driveshaft of an automotive vehicle, the method comprising:
providing a driveshaft of an automotive vehicle wherein the driveshaft has an axis of rotation about which the driveshaft is configured to rotate about upon assembly to an automotive vehicle;
determining an imbalance of the driveshaft by loading the driveshaft to a balancer wherein:
i) the balancer rotates the driveshaft about the axis of rotation;
ii) the balancer detects one or more imbalances of the driveshaft; and
iii) the balancer indicates one or more target locations upon the driveshaft to which counterweight should be added to counter the one or more imbalances;
iv) the balancer also provides an indication of how much counterweight is needed to counter the one or more imbalances;
applying a weighted adhesive to the one or more target locations based upon the indication of how much counterweight is needed to counter the one or more imbalances, wherein:
i) the adhesive includes a substantial weight percentage of one or more dense ingredients;
ii) the adhesive includes one or more polymeric materials and one or more curing agents;
iii) the adhesive include a polymeric resin selected from an epoxy based resin or a polyurethane resin;
iv) the one or more dense ingredients include tungsten;
v) the one or more dense ingredients have density of at least about 8 grams/cm³; and
vi) the weighted adhesive has a density of at least about 2 grams/cm³.

20. A method as in claim 19 wherein the driveshaft is formed of a composite material that includes fiber windings impregnated in a matrix material.

21. A method as in claim 20 wherein the driveshaft is part of a driveshaft assembly that includes a yolk and a constant velocity joint.
